(19) United States
(12) Patent Application Publication
(10) Pub. No.: US 2026/0160868 A1
(43) Pub. Date: Jun. 11, 2026

(54) METHOD FOR CALIBRATING AN ULTRASONIC SENSOR OF AN ULTRASONIC-BASED DRIVER ASSISTANCE SYSTEM OF A VEHICLE AND VEHICLE

(71) Applicant: Robert Bosch GmbH, Stuttgart (DE)

(72) Inventors: Michael Schumann, Stuttgart (DE); Albert Meszaros, Stuttgart (DE); Gergo Hodos, Korntal-Muenchingen (DE); Timo Pfeiffer, Backnang (DE)

(21) Appl. No.: 19/308,890

(22) Filed: Aug. 25, 2025

(30) Foreign Application Priority Data
Aug. 28, 2024 (DE) 10 2024 208 181.7

(51) Int. Cl. G01S 7/52; G01S 15/931

(52) U.S. Cl. CPC G01S 7/52006; G01S 15/931; G01S 2007/52012; G01S 2015/932; G01S 2015/937

(57) ABSTRACT

A method for calibrating an elevation angle of an ultrasonic sensor of an ultrasound-based driver assistance system of a vehicle.

### FIELD

The present invention relates to a method for calibrating an ultrasonic sensor of an ultrasound-based driver assistance system of a vehicle and a vehicle.

### BACKGROUND INFORMATION

Vehicles are often equipped with ultrasound-based driver assistance systems, in particular in the form of ultrasound-based parking aids, with multiple, for example 4 or 8, ultrasonic sensors which are disposed on the vehicle such that they form an ultrasonic sensor array.

A typical ultrasonic sensor of an ultrasound-based parking aid emits an ultrasonic pulse that is reflected by an object as an echo. The echo can be detected by the ultrasonic sensor, and a distance between the ultrasonic sensor and the object can be ascertained based on a duration of a time period between the emission of the ultrasonic pulse and the reception of the echo. The ultrasonic sensor can also detect the incident elevation angle and azimuth angle of the echo.

### SUMMARY

An object of the present invention is to provide a method for calibrating an ultrasonic sensor of an ultrasound-based driver assistance system of a vehicle which enables calibration of the ultrasonic sensor with a high degree of accuracy. An object of the present invention is also to provide a vehicle that is configured to carry out the method.

The =object of the present invention may be achieved by a method having certain features of the present invention and by a vehicle having certain features of the present invention. Advantageous further developments of the present invention are disclosed herein.

A method according to the present invention is suitable for calibrating, in particular an elevation angle, of an ultrasonic sensor of an ultrasound-based driver assistance system of a vehicle, wherein the vehicle is placed on a ground. According to an example embodiment of the present invention, the method comprises the steps: a) specifying a height, in particular an installation height, of the ultrasonic sensor from the ground or ascertaining the height of the ultrasonic sensor from the ground; b) detecting a plurality, for example 5 to 100, of ground echoes of an ultrasonic pulse from the ground with the ultrasonic sensor, wherein, for each ground echo, detecting the ground echoes includes measuring an elevation angle of the ground echo and measuring a duration of a time period between an emission of the ultrasonic pulse and a reception of the ground echo by the ultrasonic sensor; c) ascertaining target elevation angles of the ground echoes based on the durations measured in step b) ; d) ascertaining deviations of the elevation angles of the ground echoes measured in step b) from the target elevation angles of the ground echoes; and e) ascertaining a correction value for the detection of the elevation angle with the ultrasonic sensor based on the deviations ascertained in step d).

The use of ground echoes advantageously makes calibration of the ultrasonic sensors for measuring an elevation angle especially cost-efficient and enables said calibration to be carried out with a particularly high degree of accuracy. The ultrasonic sensors can be calibrated by ascertaining the correction values for measuring elevation angles with the ultrasonic sensor. After calibration, elevation angles of other echoes can be detected with the ultrasonic sensor with particular precision using the correction values.

Another aspect of the present invention is that the method can be carried out during use of the ultrasonic sensor, for example while detecting an object.

According to an example embodiment of the present invention, ascertaining the height of the ultrasonic sensor from the ground in step a) can include emitting an ultrasonic pulse at a maximum elevation angle of the ultrasonic sensor in the direction of the ground and receiving a ground echo, wherein ascertaining the height of the ultrasonic sensor from the ground is based on a measured duration of the time period between the emission of the ultrasonic pulse and the reception of the ground echo. The maximum elevation angle of the ultrasonic sensor can be 80°, for instance.

According to an example embodiment of the present invention, the method can comprise the step: r) for each ground echo, ascertaining a distance of a reflection point of the ground echo from the ultrasonic sensor at which the ultrasonic pulse was reflected from the ground based on the duration of the time period between the emission of the ultrasonic pulse and the reception of the ground echo by the ultrasonic sensor measured in step b), wherein ascertaining the target elevation angle in step c) for each ground echo is based on the distance ascertained in step r) and the height specified in step a).

A ground echo, the reflection point of which has a distance from the ultrasonic sensor that is greater than a specific distance, for example 3 m (meters), can be suppressed.

Ascertaining the deviations can be carried out in step d) for each ground echo by forming a difference of the measured elevation angle from the target evolution angle.

Ascertaining the correction value can be carried out in step e) by forming a median value or an average value of the deviations ascertained in step d).

According to an example embodiment of the present invention, after step b), the method can comprise the step: s) filtering the ground echoes detected in step b) such that the ground echoes with a low signal-to-noise ratio, amplitude, significance and/or correlation coefficients are filtered out. The filtering in step s) can be carried out using an echo attribute, a threshold value and/or a model that has been adapted by machine learning.

The ground can be flat. The ground cannot have any steps. The ground cannot be inclined relative to a longitudinal axis of the vehicle. The ground can preferably be parallel to the longitudinal axis of the vehicle.

According to an example embodiment of the present invention, if the ultrasonic sensor detects ground echoes and other echoes, for example from objects, the method can, prior to step d), comprise the step: filtering the ground echoes by identifying the echoes from the objects and suppressing the echoes from the objects.

After carrying out the method of the present invention, the ultrasonic sensor can detect an elevation angle of an echo, wherein the detected elevation angle is corrected by the correction value ascertained in step e). This advantageously enables the ultrasonic sensor to detect elevation angles more precisely.

In a further development of the method of the present invention, detecting the plurality of ground echoes of step b) comprises detecting a plurality of ground echoes from a plurality, for example 5 to 100, ultrasonic pulses. The method comprises the steps: f) assigning each one of the deviations ascertained in step d) to a distance range of the ultrasonic sensor so that a plurality of deviations ascertained in step d) are assigned to each distance range; and g) forming an average value of the deviations for each distance range. Ascertaining the correction value in step e) is based on the average values of the deviations formed in step g).

The ultrasonic sensor can include 4 to 10 distance ranges, for example.

In a further development of the method of the present invention, the method comprises the steps: h) ascertaining a dispersion of the deviations for each distance range; and i) ascertaining a weighting factor based on the dispersion for each distance range ascertained in step h). Ascertaining the correction value in step e) is carried out by forming the average value of the average values of the deviations formed in step g) taking into account the weighting factors ascertained in step i).

A value of the weighting factor can be inversely proportional to a value of the dispersion. The value of the weighting factor can be greater if the value of the dispersion is smaller, for example. This advantageously allows deviations of a distance range that exhibit less dispersion to be weighted more heavily.

In a further development of the method of the present invention, the method comprises the step: j) analyzing the average values formed in step g) for the presence of an outlier and suppressing the average values identified as outliers. This advantageously reduces the effect of inaccuracies, which makes it possible to calibrate the ultrasonic sensor with a particularly high degree of accuracy.

An outlier can be identified in step j), for instance if a value of a slope of a progression of the average values over the distance ranges deviates by a factor of two from the values of the other slopes.

In a further development of the method of the present invention, the method comprises the step: k) analyzing the average values formed in step g) for the presence of a trend and/or a step and terminating the method if a trend and/or a step is identified in the average values. A trend and/or step can occur in the average values if the ground is unsuitable for the method for calibrating the ultrasonic sensor. This advantageously allows the method to be terminated if the vehicle is placed on a ground that is unsuitable for the method.

In a further development of the method of the present invention, prior to step b), the method comprises the step: m) emitting the ultrasonic pulse and/or the plurality of ultrasonic pulses by means of the ultrasonic sensor. The echo detected in step b) can be a direct echo. A direct echo can be an echo that is detected by the ultrasonic sensor that emitted the ultrasonic pulse.

In a further development of the method of the present invention, step b) comprises detecting the plurality of ground echoes by means of a further ultrasonic sensor. Ascertaining the correction value in step e) is based on the ground echo detected in step b) by means of the further ultrasonic sensor. Every ground echo detected by the further ultrasonic sensor can be a cross echo. A cross echo can be an echo that is detected by an ultrasonic sensor that did not emit the ultrasonic pulse.

The above statements relating to the method of the present invention and referring to the ground echo detected by the ultrasonic sensor can apply correspondingly to the ground echoes detected by the further ultrasonic sensor.

In a further development of the method of the present invention, the method comprises the steps: n) detecting a temperature during the execution of at least one of the steps a) to e), and o) storing the correction value ascertained in step e) and the temperature detected in step n).

The correction value ascertained in step e) can be temperature-dependent. When the ultrasonic sensor is put in operation or after a reset, a temperature can be measured and the correction value corresponding to the measured temperature can be uploaded. The storing in step o) can take place in a memory of a control device for controlling the ultrasonic sensor.

In a further development of the method of the present invention, the method comprises the step: p) detecting an alignment error of the ultrasonic sensor by analyzing a history of the correction value ascertained in step e). The detection of the alignment error can advantageously be used to determine whether repair of the ultrasound-based driver assistance system is required.

The alignment error can be the result of an unwanted mechanical effect on the ultrasonic sensor, for instance; for example due to an accident.

The analysis of the history of the correction value ascertained in step e) can be an analysis to determine whether the values of the correction value ascertained in step e) exhibit a jump in the history.

The history of the correction value ascertained in step e) can comprise 20 to 100 correction values.

According to an example embodiment of the present invention, the method can comprise the step: t) outputting a warning if an alignment error is detected in step p).

A vehicle according to the present invention, in particular a motor vehicle, comprises an ultrasound-based driver assistance system, which is configured to carry out an above-described method of the present invention.

The ultrasound-based driver assistance system can be configured as an ultrasound-based parking aid.

The ultrasound-based driver assistance system can comprise a control device configured to carry out the above-described method of the present invention.

Possible embodiment examples of the present invention are explained in the following with reference to the figures.

### BRIEF DESCRIPTION OF THE DRAWINGS

FIG. 1 shows a schematic plan view onto a vehicle with an ultrasound-based driver assistance system comprising an ultrasonic sensor array, according to an example embodiment of the present invention.

FIG. 2 shows a schematic side view of the vehicle of FIG. 1.

FIG. 3 shows a schematic plan view onto two ultrasonic sensors of the ultrasonic sensor array of FIG. 1.

FIG. 4 shows a schematic illustration of a table of the ultrasound-based driver assistance system of FIG. 1.

FIG. 5 shows an example of a sequence of a method for calibrating the ultrasonic sensors of the ultrasonic sensor array of FIG. 1.

### DETAILED DESCRIPTION OF EXAMPLE EMBODIMENTS

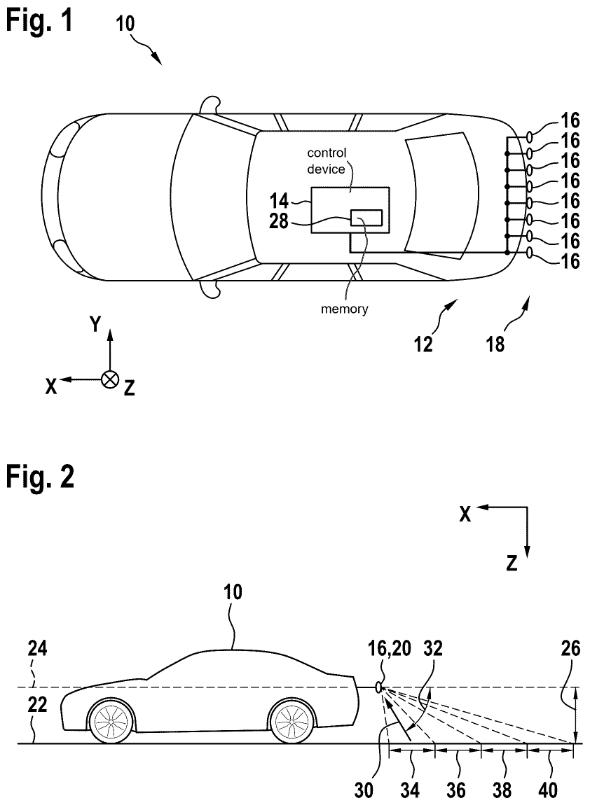

FIG. 1 shows a vehicle 10 comprising an ultrasound-based driver assistance system 12. The ultrasound-based driver assistance system 12 comprises a control device 14 and eight ultrasonic sensors 16. The ultrasonic sensors 16 are connected to the control device 14 via signals.

The ultrasound-based driver assistance system 12 is configured as ultrasound-based parking aids. The ultrasonic sensors 16 are disposed at a rear of the vehicle 10. The ultrasonic sensors 16 form an ultrasonic sensor array 18.

The ultrasound-based driver assistance system 12 is configured to carry out a method for calibrating an elevation angle of an ultrasonic sensor 16 of the ultrasonic sensor array 18.

FIG. 2 shows the vehicle 10 comprising a first ultrasonic sensor 20 of the ultrasonic sensor array 18 in an x-z plane that is subtended by a longitudinal direction and a vertical direction of the vehicle 10. The vehicle 10 is placed on a ground 22. The ground 22 is flat. The ground 22 is parallel to a longitudinal axis 24 of the vehicle 10.

The first ultrasonic sensor 20 is spaced apart from the ground 22 at a height 26. The height 26 can be referred to as the installation height. A value of the height 26 is stored in a memory 28 of the control device 14. At least one of the heights of the other ultrasonic sensors 16 from the ground 22 can be the same as or different from the value of the height 26 of the first ultrasonic sensor 20. The values of the heights of the other ultrasonic sensors 16 can be stored in the memory 28.

In an alternative not depicted embodiment example, the control device ascertains the height of the first and the second ultrasonic sensor from the ground. For this purpose, the control device can control the first ultrasonic sensor such that it emits an ultrasonic pulse at a maximum evolution angle of the first ultrasonic sensor in the direction of the ground. The control device can ascertain the height of the first ultrasonic sensor from the ground based on a measured duration of a time period between the emission of the ultrasonic pulse and the reception of a ground echo from the ultrasonic pulse by means of the first ultrasonic sensor. The control device can then control the second ultrasonic sensor such that it emits an ultrasonic pulse at a maximum evolution angle of the second ultrasonic sensor in the direction of the ground. The control device ascertains the height of the second ultrasonic sensor from the ground based on a measured duration of a time period between the emission of the ultrasonic pulse and the reception of a ground echo from the ultrasonic pulse by means of the second ultrasonic sensor.

Each ultrasonic sensor 16 is configured to emit an ultrasonic pulse and detect an echo 30 of the ultrasonic pulse shown as an example in FIG. 2. Detecting the echo 30 includes measuring an elevation angle 32 of the echo 30 at which the echo 30 hits the ultrasonic sensor 16. The elevation angle 32 can be used to localize an object in the x-z plane.

FIG. 2 shows that distance ranges are assigned to first ultrasonic sensor 20. In the embodiment example of FIG. 2, four distance ranges are shown as an example. In an alternative not depicted embodiment example, more or fewer distance ranges are assigned to the first ultrasonic sensor.

The first ultrasonic sensor 20 has a first distance range 34, a second distance range 36, a third distance range 38 and a fourth distance range 40.

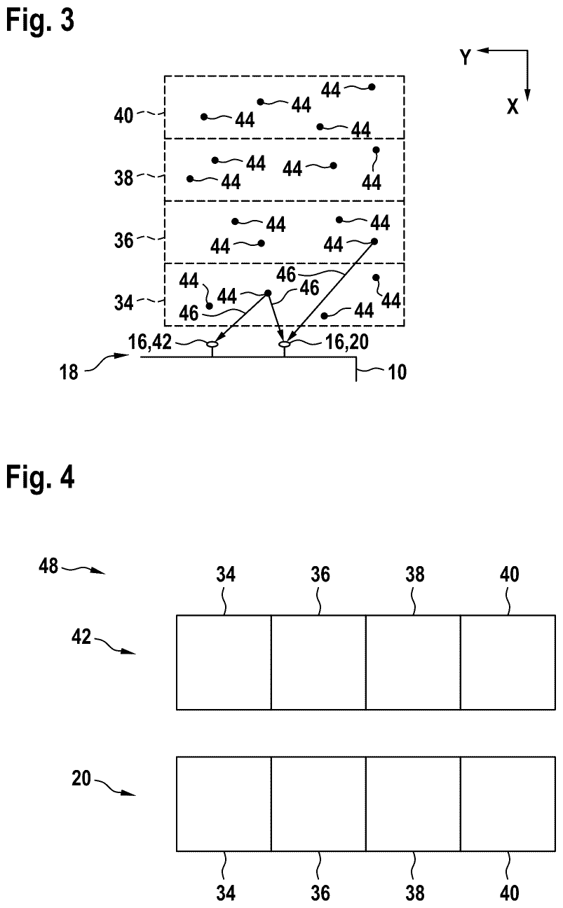

FIG. 3 shows a plan view onto the vehicle 10 during the execution of the method for calibrating the elevation angle of the first ultrasonic sensor 20 of the ultrasonic sensor array 18. A second ultrasonic sensor 42 of the ultrasonic sensor array 18 is disposed next the first ultrasonic sensor 20.

The first ultrasonic sensor 20 emits a plurality, for example six, ultrasonic pulses in succession. The ultrasonic pulses hit the ground 22 and are reflected at different reflection points 44 on the ground 22 as an echo 46. One emitted ultrasonic pulse can be reflected as an echo 46 at a single or multiple reflection points 44, for example.

The echoes 46 are detected by the first ultrasonic sensor 20 as direct echoes and by the second ultrasonic sensor 42 as cross echoes. Detecting the ground echo 46 with the first ultrasonic sensor 20 and with the second ultrasonic sensor 42 includes, for each ultrasonic sensor 20, 42, measuring an elevation angle 32 of each ground echo 46 and measuring a duration of a time period between the emission of an ultrasonic pulse and the reception of the ground echo 46 associated with the ultrasonic pulse.

In an alternative not depicted embodiment example, the first ultrasonic sensor and the second ultrasonic sensor alternately emit an ultrasonic pulse. The ultrasonic pulses can be emitted by the first ultrasonic sensor and the second ultrasonic sensor in a repeating emission pattern. The surroundings of the vehicle can thus be acquired in a particularly uniform manner.

The control device 14 filters the detected ground echoes 46 such that the ground echoes with a low signal-to-noise ratio, amplitude, significance and/or correlation coefficients are filtered out. After filtering, a ground echo 46 that has been filtered out is no longer taken into account for calibrating the first ultrasonic sensor 20.

For each ground echo 46, the control device 14 ascertains a distance of the reflection point 44 from the first ultrasonic sensor 20 and the second ultrasonic sensor 42 based on the measured duration of the time period between the emission of the ultrasonic pulse and the reception of the ground echo 46 and based on the heights 26 of the first ultrasonic sensor 20 and the second ultrasonic sensor 42 stored in the control device 14. The control device 14 can use a value of the speed of sound stored in the memory 28 for this purpose.

Based on the ascertained distances, the control device 14 assigns each reflection point 40 to one of the distance ranges 34, 36, 38, 40. In the shown embodiment example, each distance range 34, 36, 38, 40 is assigned four reflection points 40.

FIG. 3 shows that every distance range 34, 36, 38, 40 is rectangular in shape. This is not absolutely necessary. In an alternative not depicted embodiment example, it is possible for the distance ranges to not be rectangular. The distance ranges can be circular ring segment-shaped, for instance.

For each ground echo 46 and for each ultrasonic sensor 20, 42, the control device 14 ascertains a target elevation angle based on the ascertained distance of the reflection point 44 and the stored height 26 of the first ultrasonic sensor 20 and the stored height of the second ultrasonic sensor 42.

The control device 14 ascertains deviations between the measured elevation angles 32 and the ascertained target elevation angles by forming a difference between the measured elevation angles 32 and the respective associated target elevation angle.

Each ascertained deviation is assigned to the distance range 34, 36, 38, 40 of its associated reflection point 40. Each deviation is stored in the memory 28 of the control device 14 with reference to the associated distance range 34, 36, 38, 40.

FIG. 4 shows an example of a table 48 of the stored deviations. The deviations for the first ultrasonic sensor 20 are stored separately from the deviations for the second ultrasonic sensor 42. In the shown embodiment example, four deviations are stored for each ultrasonic sensor 20, 42 and for each distance range 34, 36, 38, 40.

The control device 14 ascertains a dispersion of the deviations from the target elevation angles for each ultrasonic sensor 20, 42 and for each distance range 34, 36, 38, 40. Based on the ascertained dispersion, the control device 14 ascertains a weighting factor for each distance range 34, 36, 38, 40 and for each ultrasonic sensor 20, 42. The weighting factor is greater the smaller the dispersion. Distance ranges 34, 36, 38, 40 with a lower dispersion therefore receive a larger weighting factor.

The control device 14 forms an average value or a median value of the deviations for each ultrasonic sensor 20, 42, and for each distance range 34, 36, 38, 40. In the shown embodiment example, the average value for the first ultrasonic sensor 20 and for the distance range 34 is formed from the four deviations of the distance range 34, for instance.

The control device 14 analyzes the average values of the deviations for each ultrasonic sensor 20, 42 to determine whether an average value for a distance range 34, 36, 38, 40 is an outlier. To do this, the control device can ascertain an increase between each average value and the average value of an adjacent distance range 34, 36, 38, 40. If a value of the increase for an average value deviates from the values of the other increases by a factor of 2, the control device 14 identifies this average value as an outlier. The average value identified as the outlier is suppressed. In other words, the average value identified as an outlier is not used for calibrating the first ultrasonic sensor 20.

The control device 14 analyzes the average values of the deviations for each ultrasonic sensor 20, 42 to determine whether the average values follow a trend and/or exhibit a step. A trend may be present if the average values of the deviations increase or decrease as the distance of the distance ranges 34, 36, 38, 40 from the first ultrasonic sensor 20 increases. If the control device 14 identifies a trend or a step, the control device 14 terminates the process. In the shown embodiment example, the control device 14 does not identify a trend or step.

The control device 14 ascertains a correction value for detecting an elevation angle with the first ultrasonic sensor 20 by forming an average value of the average values of the deviations of the first ultrasonic sensor 20 and the second ultrasonic sensor 42 taking into account the ascertained weighting factors. In the shown embodiment example, the average values of the distance ranges 34, 36, 38, 40 of the first ultrasonic sensor 20 and the second ultrasonic sensor 42 are multiplied by the associated weighting factors in order to then calculate the average value of the average values of the deviations.

In an alternative not depicted embodiment example, the control device can ascertain the correction value for the detection of the elevation angle with the first ultrasonic sensor by forming an average value of the average values of the distance ranges of the first ultrasonic sensor taking into account the associated weighting factors.

The ultrasound-based driver assistance system 12 also detects a temperature at which the correction value was ascertained. The temperature is stored in the memory 28 together with the correction value for the first ultrasonic sensor 20.

The control device 14 is configured to analyze a history of the correction values for the first ultrasonic sensor 20 for the presence of an alignment error of the first ultrasonic sensor 20. An alignment error can be ascertained by a sudden jump in a value of the correction value, for instance.

After carrying out the method, the first ultrasonic sensor 20 can detect an elevation angle of an echo, wherein the detected elevation angle is corrected by the stored correction value.

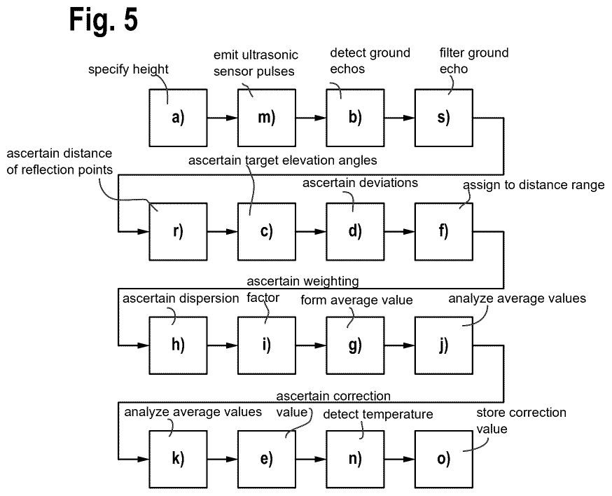

FIG. 5 shows an example of a sequence of a method for calibrating the elevation angle of the first ultrasonic sensor 20.

The method comprises the steps: a) specifying the height 26 of the first and the second ultrasonic sensor 20, 42 from the ground 22; m) emitting the plurality of ultrasonic pulses by means of the first ultrasonic sensor 20; b) detecting the plurality of ground echoes 46 by means of the first and the second ultrasonic sensors 20, 42, wherein, for each ground echo 46, detecting the ground echoes 46 includes measuring an elevation angle 32 of the ground echo 46 and measuring a duration of a time period between an emission of the ultrasonic pulse and a reception of the ground echo 46 by the first and the second ultrasonic sensor 20, 42; s) filtering the ground echo 46 detected in step b) such that the ground echoes 46 with a low signal-to-noise ratio, amplitude, significance and/or correlation coefficients are filtered out; r) for each ground echo 46, ascertaining the distance of the reflection point 44 of the ground echo 46 at which the ultrasonic pulse was reflected from the ground 22 by the first and the second ultrasonic sensors 20, 42 based on the duration of the time period between the emission of the ultrasonic pulse and the reception of the ground echo 46 by the first or second ultrasonic sensor 20, 42 measured in step b) ; c) ascertaining target elevation angles of the ground echoes 46 based on the durations measured in step b), wherein ascertaining the target elevation angle for each ground echo 46 is based on the distance ascertained in step r) and the height 26 specified in step a) ; d) ascertaining deviations of the elevation angles 32 of the ground echo 46 measured in step b) from the target elevation angles of the ground echoes 46; f) assigning each one of the deviations ascertained in step d) to a distance range 34, 36, 38, 40 of the first ultrasonic sensor 20 so that a plurality of deviations ascertained in step d) are assigned to each distance range 34, 36, 38, 40; h) ascertaining a dispersion of the deviations for each distance range 34, 36, 38, 40; i) ascertaining a weighting factor based on the dispersion for each distance range 34, 36, 38, 40 ascertained in step h) ; g) forming an average value of the deviations for each distance range 34, 36, 38, 40; j) analyzing the average values formed in step g) for the presence of an outlier and suppressing the average values identified as outliers; k) analyzing the average values formed in step g) for the presence of a trend and/or a step and terminating the method if a trend and/or step is Identified in the average values; e) ascertaining the correction value by forming the average value of the average values of the deviations formed in step g), taking into account the weighting factors ascertained in step i) ; n) detecting the temperature during the execution of at least one of the steps a) to e) ; o) storing the correction value ascertained in step e) and the temperature detected in step n).

1-10. (canceled)

11. A method for calibrating an elevation angle of an ultrasonic sensor of an ultrasound-based driver assistance system of a vehicle, wherein the vehicle is situated on a ground, and the method comprises the following steps:
a) specifying a height of the ultrasonic sensor from the ground or ascertaining the height of the ultrasonic sensor from the ground;
b) detecting a plurality of ground echoes of an ultrasonic pulse from the ground with the ultrasonic sensor, wherein, for each ground echo, the detecting of the ground echoes includes measuring an elevation angle of the ground echo and measuring a duration of a time period between an emission of the ultrasonic pulse and a reception of the ground echo by the ultrasonic sensor;
c) ascertaining target elevation angles of the ground echoes based on the durations measured in step b);
d) ascertaining deviations of the elevation angles of the ground echoes measured in step b) from the target elevation angles of the ground echoes; and
e) ascertaining a correction value for the detection of the elevation angle with the ultrasonic sensor based on the deviations ascertained in step d).

12. The method according to claim 11, wherein:
the detecting of the plurality of ground echoes in step b) includes detecting a plurality of ground echoes from a plurality of ultrasonic pulses,
the method further comprises the following step: f) assigning each one of the deviations ascertained in step d) to a distance range of the ultrasonic sensor, so that a plurality of deviations ascertained in step d) are assigned to each distance range,
the method further comprises the following step: g) forming an average value of the deviations for each distance range, and
the ascertaining of the correction value in step e) is based on the average values of the deviations formed in step g).

13. The method according to claim 12, wherein:
the method further comprises the following step: h) ascertaining a dispersion of the deviations for each distance range,
the method further comprises the following step: i) ascertaining a weighting factor based on the dispersion for each distance range ascertained in step h), and
the ascertaining of the correction value in step e) is carried out by forming an average value of the average values of the deviations formed in step g) taking into account the weighting factors ascertained in step i).

14. The method according to claim 12, wherein the method further comprises the following step: j) analyzing the average values formed in step g) for presence of outliers and suppressing the average values identified as outliers.

15. The method according to claim 12, wherein the method further comprises the following step: k) analyzing the average values formed in step g) for presence of a trend and/or a step and terminating the method when a trend and/or a step is identified in the average values.

16. The method according to claim 11, wherein, prior to step b), the following step is performed: m) emitting the ultrasonic pulse and/or a plurality of ultrasonic pulses using the ultrasonic sensor.

17. The method according to claim 11, wherein:
step b) includes detecting the plurality of ground echoes using a further ultrasonic sensor, and
the ascertaining of the correction value in step e) is based on the ground echo detected in step b) using the further ultrasonic sensor.

18. The method according to claim 11, wherein the method further comprises the following steps:
n) detecting a temperature during execution of at least one of the steps a) to e), and
o) storing the correction value ascertained in step e) and the temperature detected in step n).

19. The method according to claim 11, wherein the method further comprises the following step:
p) detecting an alignment error of the ultrasonic sensor by analyzing a history of the correction value ascertained in step e).

20. A motor vehicle, comprising:
an ultrasound-based driver assistance system configured to carry out a method for calibrating an elevation angle of an ultrasonic sensor of the ultrasound-based driver assistance system of the motor vehicle, wherein the motor vehicle is situated on a ground, and the method includes the following steps:
a) specifying a height of the ultrasonic sensor from the ground or ascertaining the height of the ultrasonic sensor from the ground;
b) detecting a plurality of ground echoes of an ultrasonic pulse from the ground with the ultrasonic sensor, wherein, for each ground echo, the detecting of the ground echoes includes measuring an elevation angle of the ground echo and measuring a duration of a time period between an emission of the ultrasonic pulse and a reception of the ground echo by the ultrasonic sensor;
c) ascertaining target elevation angles of the ground echoes based on the durations measured in step b);
d) ascertaining deviations of the elevation angles of the ground echoes measured in step b) from the target elevation angles of the ground echoes; and
e) ascertaining a correction value for the detection of the elevation angle with the ultrasonic sensor based on the deviations ascertained in step d).
